(19) United States
(12) Patent Application Publication
(10) Pub. No.: US 2004/0016450 A1
(43) Pub. Date: Jan. 29, 2004

(54) Method for reducing the formation of contaminants during supercritical carbon dioxide processes

(76) Inventors: Ronald Thomas Bertram, Gilbert, AZ (US); William Dale Jones, Phoenix, AZ (US); Douglas Michael Scott, Gilbert, AZ (US)

Correspondence Address: HAVERSTOCK & OWENS LLP, 162 NORTH WOLFE ROAD, SUNNYVALE, CA, 94086, US

(21) Appl. No.: 10/351,214

(22) Filed: Jan. 24, 2003

Related U.S. Application Data
(60) Provisional application No. 60/351,897, filed on Jan. 25, 2002.

(51) Int. Cl. B08B 3/00

(52) U.S. Cl. 134/26; 134/30; 134/36; 134/95.1; 134/103.1; 134/108; 134/111

(57) ABSTRACT

A method and system for reliably reducing the formation of particles upon wafers or substrates during wafer processes is disclosed. The method and system reduces residue contamination of a substrate material during wafer processes by pre-filling a pressure chamber to a first pressure P₁ with a purified pre-fill prior to filling the pressure chamber with a primary bulk source at a second pressure P₂. By pre-filling a chamber with purified pre-fill source at the first pressure P₁ which is substantially equal to the bulk source pressure P₂, the contaminants found in the bulk CO₂ remain within the bulk CO₂. Thus, this method and system reduces precipitation of contaminates caused by the depressurization of the bulk source during wafer processes and thereby reduces corresponding substrate material contamination.

### RELATED APPLICATION(S)

This Patent Application claims priority under 35 U.S.C. 119 (e) of the co-pending U.S. Provisional Patent Application, Serial No. 60/351,897 filed Jan. 25, 2002, and entitled “ELIMINATING FORMATION OF PARTICLES DURING SUPERCRITICAL CARBON DIOXIDE PROCESSES BY THE USE OF INERT FLUID PRE-FILL OR ALTERNATIVELY BY USE OF CLEAN CARBON DIOXIDE GAS PRE-FILL”. The Provisional Patent Application, Serial No. 60/351,897 filed Jan. 25, 2002, and entitled “ELIMINATING FORMATION OF PARTICLES DURING SUPERCRITICAL CARBON DIOXIDE PROCESSES BY THE USE OF INERT FLUID PRE-FILL OR ALTERNATIVELY BY USE OF CLEAN CARBON DIOXIDE GAS PRE-FILL” is also hereby incorporated by reference.

### FIELD OF THE INVENTION

The present invention relates to the field of cleaning processes. More particularly, the present invention relates to the field of reducing substrate material contaminants during supercritical carbon dioxide processes.

### BACKGROUND OF THE INVENTION

Carbon Dioxide (CO₂) is an environmentally friendly, naturally abundant, non-polar molecule. Being non-polar, CO₂ has the capacity to dissolve in and dissolve, a variety of non-polar materials or contaminates. The degree to which the contaminates found in non-polar CO₂ are soluble is dependant on the physical state of the CO₂. The three phases of CO₂ are solid, liquid, gas, and supercritical is a state of CO₂. These states are differentiated by appropriate combinations of specific pressures and temperatures. CO₂ in a supercritical state (SCCO₂) is neither liquid nor gas but embodies properties of both. In addition, SCCO₂ lacks any meaningful surface tension while interacting with solid surfaces, and hence, can readily penetrate high aspect ratio geometrical features more readily than liquid CO₂. Moreover, because of its low viscosity and liquid-like characteristics, the SCCO₂ can easily dissolve large quantities of many other chemicals.

It has been shown that as the temperature and pressure are increased into the supercritical state, the solubility of CO₂ also increases. This increase in solubility has lead to the development of SCCO₂ cleaning, extractions, and degreasing. As the via and line geometries progress to the smaller dimensions and larger depth to width ratios in semiconductor processes, the plasma ashing and the stripper bath processes of the prior art are becoming less effective and for some processes ineffective at removal of photoresist and photoresist residue. Further, removal of photoresist or residue from oxide materials presents a difficult problem because the photoresist and the residue tend to bond strongly to oxide materials. Thus, a new process is needed for applications of semiconductor processing, surface cleaning, and depositions steps especially when penetration of very tight geometrical features is present.

### SUMMARY OF THE INVENTION

A thorough SCCO₂ wafer cleaning that removes traces of contaminates is performed to ensure high yield, optimize fabrication results, and reduce adverse effects on the characteristics of the processed device. Contaminates can generally be categorized as: (1) Metallic (where metallic contaminant atoms such as Fe, Al, Cu, Ca, Na are deposited on the Si surface during device processing causing major reliability problems); (2) Organic (main sources include hydrocarbons from ambient air and storage/shipping facilities, which, if not controlled, can cause reliability problems as well as have an adverse effect on the characteristics of metal-semiconductor contacts and epitaxial layers); (3) Oxide (caused by oxygen, nitrogen, carbon monoxide, water, and hydrocarbons); or (4) Particles. The particle contaminants are typically pieces of various materials such as photoresist, silicon, silica, metallics, skin flakes, or colonies of bacteria, which are present in the process environment. Even ultra-small contaminants (<0.1 m) on the wafer surface can cause catastrophic damage.

Clean-room technologies serve to prevent wafer surface contamination but still fall short of eliminating these various contaminants. Furthermore, methods of purifying CO₂ to a level necessary to meet the needs of SCCO₂ cleaning currently do not exist. There has been a concerted effort by suppliers to increase the purity of CO₂ and inert gases and supply cleaner bulk CO₂ and inert gases by reducing the levels of contaminates inherently present. This is an extremely difficult task due to the aggressive behavior of CO₂ with non-polar material sources present during the manufacturing and bottling process. For SCCO₂ cleaning applications, the non-volatile, heavy molecular weight molecules dissolved in the CO₂ are the main noticeable contaminates. These heavy molecular weight molecules include large molecular weight hydrocarbons (greater than C₁₂) and molecules that polymerize once out of the CO₂ (forming large non-reactive clusters).

Even with increased purity of bulk CO₂ and inert gases, there are still contaminants found within the bulk sources which reduce the effectiveness of current wafer processes. Thus, a more effective and efficient method of and system for keeping unwanted dissolved or condensed contaminates contained within the bulk sources throughout processing is needed.

The present invention is directed to a method of and system for reducing the formation of particles during SCCO₂ processes by the use of a purified pre-fill comprised of either CO₂ or inert gas, or a combination of CO₂ and inert gas. Prevention of even ultra-small particle (<0.1 m) contamination on the wafer surface is imperative to reduce or eliminate catastrophic wafer damage.

A number of water based techniques and systems have been developed which utilize supercritical solutions for cleaning wafers. But water can be deleterious because of oxide formation and the difficulty in removing water from the cleaning system. Further, the presence of water can lead to unpredictable chemistry of the supercritical cleaning solution.

The current invention addresses this and other problems and difficulties associated with supercritical wafer cleaning techniques and systems. The current invention comprises of a method to pre-pressurize a process chamber with a purified pre-fill comprising either CO₂ or inert gas, or a combination of CO₂ and inert gas. This purified pre-fill keeps the bulk CO₂ source from depressurizing once added which causes contaminates to condense and precipitate in the pressure chamber.

Although other ways exist, a purified source can generally be obtained in one of two ways: (1) Attaching a filtration scheme to the gas or liquid outlet port of a high-pressure CO₂ or inert gas cylinder shown in FIG. 1; or (2) attaching a purification scheme to the gas or liquid outlet port of a high-pressure CO₂ or inert gas cylinder, shown in FIG. 2.

Once a purified pre-fill source (comprising either CO₂ or inert gas, or a combination of CO₂ and inert gas) is produced, the purified source is flowed directly into the pressure chamber. The purified source pressure is maintained by the use of a valve or back-pressure regulator located downstream from the pressure chamber. With the valve or back-pressure regulator adjusted to a pressure corresponding to that of the bulk CO₂ source pressure (e.g., ˜830 psi), the purified source pressurizes the chamber as a pre-fill. While maintaining the purified source at a constant pressure, the CO₂ bulk source is then added and allowed to flow into and thru the chamber. Once the bulk CO₂ in the pressure chamber reaches equilibrium pressure, the system is pressurized to a supercritical state (e.g., ˜2750 psi). When CO₂ is used for both the pre-fill and the process, the dissociation of the contaminants contained within the bulk source CO₂ is reduced.

Following the operations of pre-filling the pressure chamber with a purified pre-fill source and introducing the bulk source into the pressure chamber as described above, the supercritical cleaning procedure is initiated. After completing the cleaning process, the pressure chamber is depressurized to atmospheric pressure.

### BRIEF DESCRIPTION OF THE DRAWINGS

FIG. 1 illustrates a schematic diagram showing an apparatus for a purified pre-fill source utilizing a filtration scheme.

FIG. 2 illustrates a schematic diagram of an apparatus for utilizing how to obtain a purified pre-fill source by a purification scheme.

FIG. 3 illustrates the preferred processing system of the present invention.

FIG. 4 illustrates an alternative embodiment of the processing system of the present invention.

FIG. 5 is a flow chart illustrating steps of the preferred method of the present invention.

### DETAILED DESCRIPTION OF THE PREFERRED EMBODIMENT

The present invention is directed to a method and system for reducing contaminants deposited upon wafers and other substrate materials (including but not limited to silicon-based and metal-based substrate materials) during wafer processes. The present invention preferably utilizes a purified pre-fill (comprised of either CO₂ or inert gas, or a combination of CO₂ and inert gas) prior to conducting a supercritical CO₂ cleaning process to remove residue from a silicon oxide material. The present invention is preferably directed to reducing wafer or substrate material contamination by pre-filling a chamber with pressurized purified pre-fill source and maintaining the pressure of the bulk CO₂ source. This causes any contaminants found in the bulk CO₂ to remain within the bulk CO₂. Thus, wafer or substrate material contamination is minimized or eliminated.

While the present invention is described in relation to applications for removing post etch residue material typically used in wafer processing, it will be clear to one skilled in the art that the present invention can be used in a procedure to remove any number of different residues (including but not limited to polymers and oil) from any number of different materials (including but not limited to silicon nitrides) and structures including but not limited to micro-mechanical, micro-optical, micro-electrical structures and combination thereof.

In accordance with the preferred embodiment of the present invention, a means to pre-pressurize a wafer pressure chamber with a purified pre-fill (comprised of either CO₂ or inert gas, or a combination of CO₂ and inert gas) source in order to keep the bulk CO₂ source, once added, from depressurizing and allowing contaminates to condense in the pressure chamber is shown.

In current wafer processing methods, bulk CO₂ is introduced into a pressure chamber containing the wafer. Typically, this chamber is in a clean room at atmospheric pressure and room temperature. In contrast, the bulk CO₂ is preferably pressurized to approximately 800-1000 psi. Due to pressure and temperature differentials, an expansion jet is created with the high pressure bulk CO₂ entering the chamber. With this expansion, dissolved or condensed contaminants contained within the bulk CO₂ are passed onto the surface of the wafer. The bulk CO₂ contaminants are transferred onto the wafer surface as dry ice crystals (“snow”), liquid spray, or dissolved or condensed particles dropping onto the wafer surface.

If the bulk CO₂ is kept from depressurizing during the filling process (when the chamber is pressurized) and/or the emptying process (when the chamber is depressurized), contaminates remain soluble in the bulk CO₂ and are reduced or eliminated during standard wafer processing. It was discovered that to resolve this problem, there is a need to pre-pressurize the wafer pressure chamber with a purified pre-fill (comprised of either CO₂ or inert gas, or a combination of CO₂ and inert gas) prior to introducing bulk CO₂ into to chamber. It was also discovered that adding a purified inert gas pre-fill immediately before and/or after the bulk CO₂ is added to both fill and evacuate the chamber of all purified CO₂ also resolved the current wafer contamination problems.

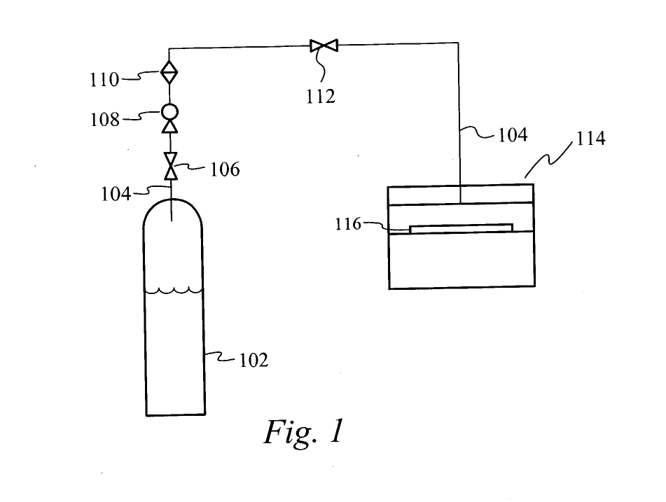

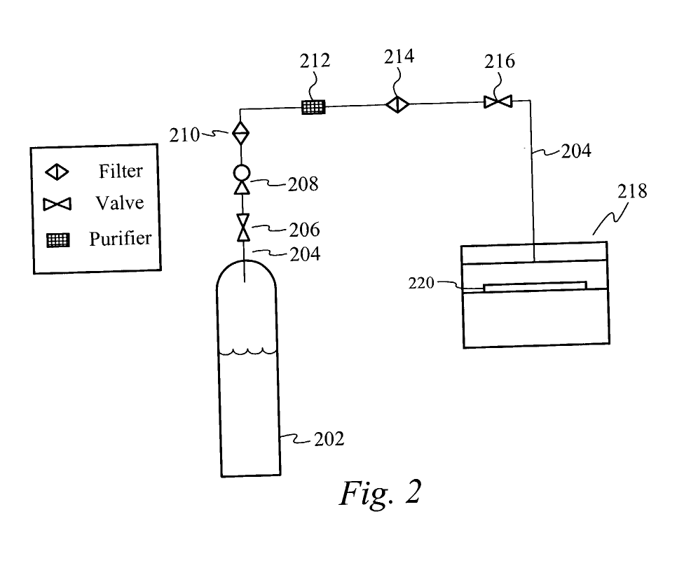

First, in the preferred embodiment of the current invention, bulk CO₂ is flowed out of a cylinder and thru a filtration/purification scheme, shown in FIGS. 1 and 2, to create a purified CO₂ pre-fill source. In alternate embodiments of the current invention, bulk inert gas, or a combination of bulk inert gas and CO₂, is flowed out of a cylinder and thru a filtration/purification scheme, shown in FIGS. 1 and 2, to create a purified inert gas (or combination inert gas/CO₂) source. Then this purified pre-fill source (comprised of either CO₂ or inert gas, or a combination of CO₂ and inert gas) is flowed directly into the pressure chamber.

In an embodiment of the preferred invention, the pressure of the purified pre-fill is maintained at P₁ by the use of a valve or back-pressure regulator located downstream of the pressure chamber. The purified CO₂ acts as a pre-fill and pressurizes the pressure chamber to a purified pre-fill pressure P₁. In the preferred embodiment of the current invention, the purified pre-fill pressure P₁ is substantially equal to the bulk source pressure P₂. Alternatively, P₁ is equal to a supercritical pressure. In yet another embodiment of the current invention, P₁ is greater than P₂ with the bulk source at a pressure P₂ is pumped into the pressure chamber while the purified pre-fill pressure P₁ is simultaneously vented from the chamber. While maintaining the purified pre-fill source pressure and the pressure chamber pressure at P₁, the bulk CO₂ source at a pressure P₂, is then added and allowed to flow into and thru the chamber displacing all of the purified pre-fill source.

In operation, a supercritical cleaning solution is generated in a pressurized or compression chamber with a substrate structure comprising a substrate material and a residue therein. The substrate material can be any suitable material but is preferably a silicon based material and the residue is preferably a polymeric residue, such as a post etch photopolymer residue. The supercritical cleaning solution preferably comprises supercritical CO₂. The supercritical cleaning solution is preferably agitated and/or circulated around the substrate structure to facilitate the cleaning process. The supercritical cleaning solution removes the residue from the substrate structure by dissolving the residue, etching the residue, etching a portion of the substrate material or any combination thereof. After the residue is removed from the substrate structure, the supercritical cleaning solution is decompressed or exhausted from the chamber along with the reside.

The cleaning process is performed any number of times on the substrate structure and includes any number of compression and decompression cycles necessary to remove the residue from the substrate structure. Further details of supercritical systems suitable for cleaning post etch residues from wafer substrates are described in U.S. patent application Ser. No. 09/389,788, filed Sep. 3, 1999, and entitled “REMOVAL OF PHOTORESIST AND PHOTORESIST RESIDUE FROM SEMICONDUCTORS USING SUPERCRITICAL CARBON DIOXIDE PROCESS and U.S. patent application Ser. No. 09/697,222, filed Oct. 25, 2000, and entitled “REMOVAL OF PHOTORESIST AND RESIDUE FROM SUBSTRATE USING SUPERCRITICAL CARBON DIOXIDE PROCESS”, both of which are hereby incorporated by reference.

After completing the cleaning process, the pressure chamber is depressurized to atmospheric pressure. The silicon wafer in the chamber was then tested by a Tencor SP1 particle monitor. The results of the particle measurements indicated that the CO₂ cleaning processes with a purified pre-fill had several orders of magnitude fewer particle counts and defect densities than identical runs without pre-fill.

Regardless of the method used to process a micro device or the material used therein, there is typically one or more step whereby the wafer becomes contaminated with processing residues. These results verify that if a purified pre-fill source is used prior to adding a bulk source and the pressure of the bulk CO₂ source is maintained during the filling process, the solubility remains high and particles do not condense out of the bulk source. The results of the particle measurements indicated that the CO₂ cleaning processes with a pre-fill had several orders of magnitude fewer contaminant counts than identical runs without the pre-fill. Test results showed high defect densities when the chamber was not pre-filled. It is believed that by pre-pressurizing (pre-filling) a pressure chamber with a purified pre-fill, the contamination of silicon wafers is a reduced. Thus, this method will allow for SCCO₂ applications to proceed many years before contaminate free CO₂ source can be developed and implemented.

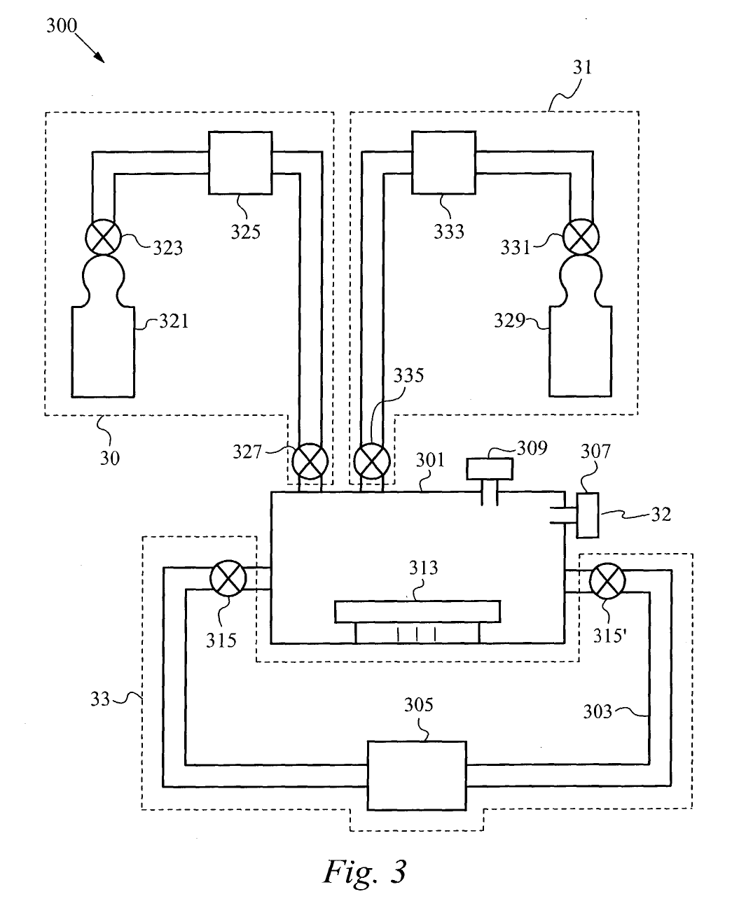

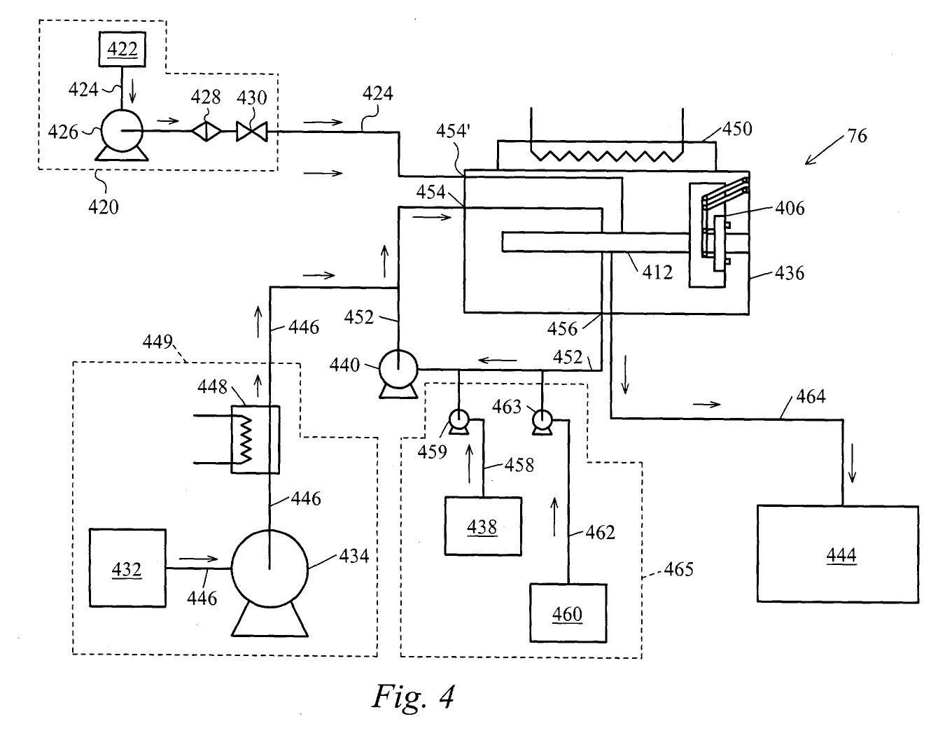

Referring to FIGS. 1 and 2, in accordance with the embodiments of the invention, a purified pre-fill source (comprised of either CO₂ or inert gas, or a combination of CO₂ and inert gas) is obtained. FIG. 1 shows bulk gas or liquid filtration scheme, while FIG. 2 details bulk gas or liquid purification scheme. These filtration/purification schemes are each described separately below and can be utilized within the pre-fill source described in FIG. 3 and the purified pre-fill source supply arrangement described in FIG. 4.

Specifically, FIG. 1 shows a pre-fill source gas or liquid supply vessel 102 coupled to a pre-fill source supply line 104. The pre-fill source supply line 104 is coupled to a pre-fill source valve 106. The pre-fill source valve 106 is coupled to a pre-fill source supply pump 108. The pre-fill source supply pump 108 is coupled to a pre-fill source filter 110. The pre-fill source filter 110 is coupled to a pre-fill source valve 112. The pre-fill source supply line 104 supplies a filtered pre-fill source to a pressure chamber 114. A wafer 116 to be treated is contained within the pressure chamber 114.

Next, FIG. 2 illustrates pre-fill source gas or liquid supply vessel 202 coupled to a pre-fill source supply line 204. The pre-fill source supply line 204 is coupled to a pre-fill source valve 206. The pre-fill source valve 206 is coupled to a pre-fill source supply pump 208. The pre-fill source supply pump 208 is coupled to a pre-fill source filter 210. The pre-fill source filter 210 is coupled to a pre-fill source purifier 212. The pre-fill source purifier 212 is coupled to a second pre-fill source filter 214. The second pre-fill source filter 214 is coupled to a second pre-fill source valve 216. The location of the first and second pre-fill source purifiers and filters can be relocated as desired. The pre-fill source supply line 204 supplies a purified pre-fill source to a pressure chamber 218. A wafer 220 to be treated is contained within the pressure chamber 218.

In FIG. 3, the preferred embodiment of the present invention is illustrated. Specifically, the system 300 for reliably reducing the formation of particles upon wafers or substrates during wafer processes comprises a pre-fill source 30, a bulk source 31, a wafer processing chamber 32, and a recirculation loop 33.

The pre-fill source 30 comprises a pre-fill source vessel 321, a pre-fill source pressure regulator 323, a pre-fill source supply arrangement 325, and a second pre-fill source pressure regulator 327. The pre-fill source vessel 321 is coupled to a first pre-fill source pressure regulator 323. The first pre-fill source pressure regulator 323 is coupled to a pre-fill source supply arrangement 325. The pre-fill source supply arrangement 325 comprises a purification means, a pre-fill source pump, and a pre-fill source heater. The pre-fill source supply arrangement 325 is coupled to a second pre-fill source pressure regulator 327. The second pre-fill source pressure regulator 327 is coupled to the pressure chamber 301.

The bulk source 31 comprises a bulk source vessel 329, a first bulk source pressure regulator 331, a bulk source supply arrangement 333, and a second bulk source pressure regulator 335. The 329 bulk source vessel is coupled to a first bulk source pressure regulator 331. The first bulk source pressure regulator 331 is coupled to a bulk source supply arrangement 333 comprising a bulk source pump and a bulk source heater. The bulk source supply arrangement 333 is coupled to a second bulk source pressure regulator 335. The second bulk source pressure regulator 335 is coupled to the pressure chamber 301.

Still referring to FIG. 3, the wafer processing chamber 32 comprises a pressure chamber 301, a substrate load-lock 313, a first exhaust 307, and a second exhaust 309. The pressure chamber 301 is coupled to a exhaust 33. The recirculation loop 33 comprises a first pressure chamber pressure regulator 315, a second pressure chamber pressure regulator 315′, recirculation piping 303, and a recirculation storage vessel 305. The first 315 and second 315′ pressure chamber pressure regulators are coupled to a exhaust storage vessel 305 via recirculation piping 303.

FIG. 4 illustrates an alternate embodiment of the preferred invention. Referring to FIG. 4, a pressure chamber 76 for cleaning a wafer with a supercritical cleaning solution is illustrated. The pressure chamber 76 includes a purified pre-fill source supply arrangement 420, a supercritical processing chamber 436, a circulation pump 440, an exhaust gas collection vessel 444, a bulk source supply arrangement 449, and a supercritical cleaning and rinse solution source supply arrangement 465.

The bulk source supply arrangement 449 comprises a bulk source supply vessel 432, a bulk source pump 434, bulk source piping 446, and a bulk source heater 448. The bulk source supply arrangement 449 is coupled to a circulation line 452 via the bulk source piping 446. The bulk source pump 434 is located on the bulk source piping 446. The bulk source heater 448 is located along the bulk source piping 446 between the bulk source pump 434 and the circulation line 452.

The purified pre-fill source supply arrangement 420 comprises a purified pre-fill source supply vessel 422, a purified pre-fill source piping 424, a purified pre-fill source pump 426, a purified pre-fill source filter 428, and a purified pre-fill source valve 430. The purified pre-fill source supply arrangement 420 is coupled to the supercritical processing chamber 436 via the purified pre-fill source pump 426 and the purified pre-fill source piping 424. The a purified pre-fill source pump 426 is located on the purified pre-fill source piping 424, which couples to the supercritical processing chamber 436 at a purified pre-fill circulation inlet 454′.

The circulation pump 440 is located on a circulation line 452, which couples to the supercritical processing chamber 436 at a circulation inlet 454 and at a circulation outlet 456.

The supercritical cleaning and rinse solution source supply arrangement 465 comprises a chemical supply vessel 438, a chemical supply line 458, a rinse agent supply vessel 460, and a rinse supply line 462. The chemical supply vessel 438 is coupled to the circulation line 452 via the chemical supply line 458. The rinse agent supply vessel 460 is coupled to the circulation line 452 via the rinse supply line 462. The chemical supply line 458 includes a chemical supply injection pump 459. The rinse supply line 462 includes a rinse supply injection pump 463.

The supercritical processing chamber 436 is comprised of a gate valve 406, wafer cavity 412, and a heater 450. The exhaust gas collection vessel 444 is coupled to the supercritical processing chamber 436 via a exhaust gas piping 464.

It will be readily apparent to one skilled in the art that the pressure chamber 76 includes valving, control electronics, filters, and utility hookups which are typical of supercritical fluid processing systems.

Still referring to FIG. 4, in operation, a wafer with a residue thereon is inserted into the wafer cavity 412 of the supercritical processing chamber 436 and the supercritical processing chamber 436 is sealed by closing the gate valve 406. The supercritical processing chamber 436 is pre-filled by the purified pre-fill source supply arrangement 420 through the through the purified pre-fill source piping 424 as detailed above. The purified pre-fill source valve 430 maintains the purified pre-fill at a constant pressure P₁. In the preferred embodiment of the current invention, the purified pre-fill pressure P₁ is substantially equal to the bulk source pressure P₂. Alternatively, P₁ is equal to a supercritical pressure. In yet another embodiment of the current invention, P₁ is greater than P₂ with the bulk source at a pressure P₂ is pumped into the pressure chamber while the purified pre-fill pressure P₁ is simultaneously vented from the chamber. While maintaining the purified pre-fill source pressure and the pressure chamber pressure at P₁, the bulk CO₂ source at a pressure P₂, is then added and allowed to flow into and thru the chamber displacing all of the purified pre-fill source. In alternative embodiments, the purified pre-fill source supply arrangement 420 can be configured to supply purified or filtered pre-fill CO₂, inert gas, or a combination of CO₂ and inert gas source as demonstrated in FIGS. 1 and 2. Once the chamber is pre-filled with a purified pre-fill source, the supercritical processing chamber 436 is pressurized with a bulk source by the bulk source supply arrangement 449. The bulk source is heated by the bulk source heater 448 and is at a pressure P₂. This bulk source pressure of P₂ is preferably substantially equal to the purified pre-fill source pressure of P₁. The purified pre-fill is displaced out of the supercritical processing chamber 436 through the exhaust gas piping 464 and recycled or exhausted in the exhaust gas collection vessel 444.

Once the purified pre-fill is exhausted from the supercritical processing chamber 436 by the bulk source, the supercritical processing chamber 436 is heated by the heater 450 to ensure that a temperature of the bulk source contained within the supercritical processing chamber 436 is above a critical temperature. In embodiments of the invention, the bulk source is a bulk carbon dioxide (the critical temperature for bulk carbon dioxide is 31° C.). Preferably, the temperature of the bulk carbon dioxide in the supercritical processing chamber 436 is within a range of 45° C. to 75° C. Alternatively, the temperature of the bulk carbon dioxide in the supercritical processing chamber 436 is maintained within a range of from 31° C. to approximately 100° C.

Upon reaching initial supercritical conditions, the chemical supply pump 459 pumps stripper chemistry from a chemical supply vessel 438 into the supercritical processing chamber 436 via the circulation line 452 while the supercritical bulk source is further pressurized by the bulk source pump 434. At the beginning of the addition of the stripper chemistry to the supercritical processing chamber 436, the pressure in the supercritical processing chamber 436 is preferably approximately 2,000 psi. Once a desired amount of the stripper chemistry has been pumped into the supercritical processing chamber 436 and desired supercritical conditions are reached, the bulk source pump 434 stops pressurizing the supercritical processing chamber 436, the chemical supply pump 459 stops pumping stripper chemistry into the supercritical processing chamber 436, and the circulation pump 440 begins circulating the supercritical cleaning solution comprising the supercritical bulk source and the stripper chemistry. Preferably, the pressure at this point in the method is approximately 2,700-2,800 psi. By circulating the supercritical cleaning solution, solution is replenished quicky at the surface of the wafer thereby enhancing the removal of the photoresist and the residue from the wafer. Preferably, the wafer is held stationary within the supercritical processing chamber 436 during the cleaning process. Alternatively, the wafer is spun within the supercritical processing chamber 436 during the cleaning process.

The pressure chamber partially decompresses, the rinse supply pump 463 pumps a rinse agent from the rinse agent supply vessel 460 into the supercritical processing chamber 436 via the circulation line 452 while the bulk source pump 434 re-pressurizes the supercritical processing chamber 436 to near the desired supercritical conditions to generate a supercritical rinse solution. The supercritical rinse solution is then circulated with the circulation pump 440 to rinse the wafer of stripper chemistry used during the cleaning cycle. Again the wafer is preferably held stationary in the supercritical processing chamber 436 during the rinse cycle or, alternatively, the wafer is spun within the supercritical processing chamber 436 during the rinse cycle.

After the wafer is treated to the supercritical rinse solution (re-pressurized to a set pressure of approximately 2,700-2,800 p.s.i.), then the supercritical processing chamber 436 is depressurized, by exhausting the supercritical processing chamber 436 to the exhaust gas piping 464 into the exhaust gas collection vessel 444 and the wafer is removed from the supercritical processing chamber 436 through the gate valve 406.

Any number of cleaning cycles and rinse cycles sequences with each cycle having any number of compression and decompression steps are contemplated and the example above is intended for illustration and completeness only and is no way intended to limit the scope the present invention. Also, various chemicals and species within supercritical cleaning and rinse solutions can be readily tailored for the application at hand.

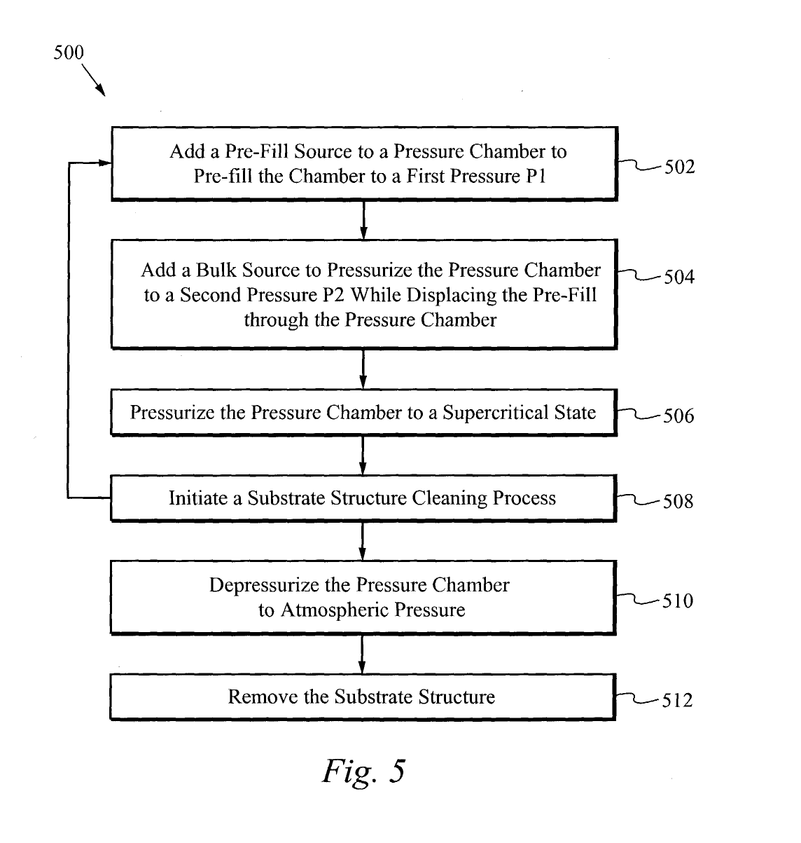

FIG. 5 is a flow chart 500 outlining steps for efficiently and effectively cleaning and treating a substrate structure comprising any number of different structural features formed from any number of different material by pre-filling a pressure chamber with a purified CO₂ (or inert gas) source. In the step 502, a pre-fill source is added to a pressure chamber to pre-fill the chamber to a first pressure P₁. The pressure chamber containing a substrate structure with a residue, such a post etch photopolymer residue, is pre-pressurized with this pre-fill. After a pre-fill source is added to a pressure chamber to pre-pressurize the chamber to a first pressure P₁ in the step 502, then in the step 504 a bulk source is added to pressurize the pressure chamber to a second pressure P₂ while displacing the pre-fill through the pressure chamber. The first pressure P₁ is preferably substantially equal to the second pressure P₂. After a bulk source is added to pressurize the pressure chamber to the second pressure P₂ while displacing the pre-fill through the pressure chamber in the step 504, then in the step 506 the pressure chamber is pressurized to a supercritical state. Once the pressure chamber is pressurized to a supercritical state in step 506, then a substrate structure cleaning process is initiated in step 508. During the step 508, the substrate structure is exposed to the supercritical cleaning solution and maintained in the supercritical cleaning solution for a period of time required to remove at least a portion of the residue material from the substrate structure. Furthermore, during the step 508, the supercritical cleaning solution is preferably circulated through the chamber and/or otherwise agitated to move the supercritical cleaning solution over the surface of the substrate.

After at least a portion of the residue is removed from the substrate in the step 508, the chamber is depressurized to atmospheric pressure in the step 510. The cleaning process comprising the step 508 can be repeated any number of times as required to remove the residue from the substrate structure using a fresh pre-fill source, bulk source, and supercritical cleaning solution, as indicated by the arrow connecting the steps 508 to 502.

After the pre-fill process, the cleaning process or cycle, and the depressurizing process comprising the steps 502, 504, 506, 508, and 510 are complete, then the substrate structure, in accordance with alternative embodiments of the invention, is treated to a supercritical rinsing solution. The supercritical rinsing solution preferably comprises supercritical CO₂ and one or more organic solvents, but can be pure supercritical CO₂.

Still referring to FIG. 5, after the substrate structure is cleaned in the step 508, and the chamber is depressurized in the step 510, the substrate structure is removed from the chamber in the step 512. Alternatively, the substrate structure is recycled through the pre-fill process and the cleaning process comprising the steps 502, 504, 506 and 508 as indicated by the arrow connecting steps 508 and 502. In alternative embodiments of the present invention, the substrate structure is cycled through several rinse cycles prior to removing the substrate structure from the chamber in the step 512.

Also, it will be clear to one skilled in the art that any number of different treatment sequences are within the scope of the invention. For example, cleaning steps and rinsing steps can be combined in any number of different ways to achieve removal of a residue from a substrate structure. Even with increased purity of bulk CO₂ and inert gases, there are still contaminants found within the bulk sources which reduce the effectiveness of current wafer processes. Thus, a more effective and efficient method of and system for keeping unwanted dissolved or condensed contaminates contained within the bulk sources throughout processing is needed. Embodiments of this current invention serve as a possible solution to the contamination problems faced in using bulk CO₂ or inert gases in wafer processes. By using the current method and system, particles remain dissolved in the CO₂ and do not contaminate wafers. This current invention would have positive ramifications on current wafer fabrication and SCCO₂ cleaning processes. Furthermore, this solution would permit supercritical cleaning to become the preferred manner for cleaning in the semiconductor industry in the very near future.

The present invention has been described in terms of specific embodiments incorporating details to facilitate the understanding of the principles of construction and operation of the invention. Such reference herein to specific embodiments and details thereof is not intended to limit the scope of the claims appended hereto. It will be apparent to those skilled in the art that modifications may be made in the embodiments chosen for illustration without departing from the spirit and scope of the invention. For example, while purified CO₂ is the preferred medium for pre-filling the chamber prior to conducting cleaning of supercritical media via bulk CO₂, use of purified inert gases as pre-fill is also contemplated.

What is claimed is:

1. A method comprising:
a. adding a pre-fill source to a pressure chamber to pre-fill the pressure chamber to a first pressure;
b. adding a bulk source to pressurize the pressure chamber to a second pressure while displacing the pre-fill through the pressure chamber;
c. initiating a substrate structure cleaning process; and
d. depressurizing the pressure chamber to atmospheric pressure.

2. The method of claim 1, wherein the first pressure is greater than the second pressure.

3. The method of claim 1, wherein the first pressure is substantially equal to the second pressure.

4. The method of claim 1, wherein the first pressure is supercritical.

5. The method of claim 1, wherein the substrate structure cleaning process is initiated by increasing the second pressure such that the bulk source contained within the pressure chamber reaches a supercritical state.

6. The method of claim 1, wherein the substrate structure cleaning process is performed any number of times.

7. The method of claim 1, wherein the substrate structure cleaning process includes any number of compression and decompression cycles necessary to remove the residue from the substrate structure.

8. The method of claim 1, wherein the pre-fill source is purified.

9. The method of claim 1, wherein the pre-fill source is a purified CO₂.

10. The method of claim 1, wherein the pre-fill source is a purified inert gas.

11. The method of claim 1, wherein the pre-fill source is a combination of purified CO₂ and a purified inert gas.

12. The method of claim 1, wherein the bulk source is CO₂.

13. The method of claim 1, wherein the bulk source is supercritical CO₂.

14. The method of claim 1, wherein the substrate structure cleaning process comprises removal of residue from a substrate material.

15. The method of claim 14, wherein the substrate material comprises a silicon dioxide.

16. The method of claim 1, further comprising rinsing the substrate material with a supercritical rinsing solution following completion of the substrate structure cleaning process.

17. The method of claim 16, wherein the supercritical rinsing solution comprises CO₂ and an organic solvent.

18. A system for reliably reducing the formation of particles upon wafers or substrates during wafer processes, the system comprising:
a. a pre-fill source;
b. a bulk source;
c. a pressure chamber; and
d. an exhaust.

19. The system of claim 18, wherein the pressure chamber is a wafer processing chamber.

20. The system of claim 18, wherein the pressure chamber is a supercritical processing module.

21. The system of claim 18, wherein the pre-fill source is a purified CO₂.

22. The system of claim 18, wherein the pre-fill source is a purified inert gas.

23. The system of claim 18, wherein the bulk source is CO₂.

24. The system of claim 18, wherein the pre-fill source is coupled to a purification means for purifying the pre-fill.

25. The system of claim 18, wherein the pre-fill source is coupled to a filtration means for purifying the pre-fill.

26. The system of claim 18, wherein the pre-fill source is coupled to a plurality of pressure regulators for maintaining pressure.

27. The system of claim 18, wherein the pre-fill source is coupled to the pressure chamber for establishing a first pressure.

28. The system of claim 18, wherein the bulk source is coupled to a bulk source supply arrangement.

29. The bulk source supply arrangement of claim 28 comprises a bulk source pump coupled to a bulk source heater.

30. The system of claim 18, wherein the bulk source is coupled to a plurality of pressure regulators for maintaining pressure.

31. The system of claim 18, wherein the bulk source is coupled to the pressure chamber for establishing a second pressure

32. The system of claim 18, wherein the pressure chamber is coupled to plurality of exhausts.

33. The system of claim 18, wherein the pressure chamber is coupled to a substrate structure load-lock to introduce a wafer into the pressure chamber.

34. The system of claim 18, wherein the pressure chamber is coupled to plurality of pressure regulators for maintaining pressure.

35. The system of claim 18, wherein the pressure chamber is coupled to a exhaust storage vessel for storage of circulated bulk and pre-fill sources via exhaust piping.

36. A method of cleaning a substrate comprising:
a. pre-filling a pressure chamber containing the substrate with a pre-fill at a first pressure;
b. generating a supercritical cleaning environment to clean the substrate by adding a bulk source at a second pressure to the pressure chamber to displace the pre-fill;
c. circulating a supercritical cleaning to clean the substrate;
d. circulating a supercritical rinsing solution to rinse the substrate; and
e. removing the supercritical cleaning solution and the supercritical rinse solution.

37. The method of claim 36, wherein the pre-fill comprises purified CO₂.

38. The method of claim 36, wherein the pre-fill comprises purified inert gas.

39. The method of claim 36, wherein the bulk source comprises CO₂.

40. The method of claim 36, wherein the bulk source comprises supercritical CO₂.

41. The method of claim 36, wherein the supercritical cleaning solution comprises supercritical CO₂ and one or more organic solvents.

42. The method of claim 36, further comprising pre-filling the chamber with purified inert gas CO₂ prior to introducing a supercritical cleaning solution comprising supercritical CO₂.

43. The method of claim 36, wherein removing the supercritical cleaning solution comprises flushing the chamber with supercritical CO₂.

44. The method of claim 36, wherein the supercritical cleaning solution comprises supercritical CO₂ and an anhydrous fluoride source.

45. The method of claim 36, wherein the first pressure is greater than the second pressure.

46. The method of claim 36, wherein the first pressure is equal to the second pressure.

47. The method of claim 36, wherein the first pressure is supercritical.
